(19) United States
(12) Patent Application Publication
(10) Pub. No.: US 2024/0295008 A1
(43) Pub. Date: Sep. 5, 2024

(54) Separation of base metals

(71) Applicant: Gelion Technologies Pty Ltd., North Sydney (AU)

(72) Inventors: Daniel Marin Florido, Sonning Common (GB); Paul Noel O'Shaughnessy, Sonning Common (GB); James Stevens, Sonning Common (GB)

(21) Appl. No.: 18/568,450

(22) PCT Filed: Apr. 12, 2022
(86) PCT No.: PCT/GB2022/050913

§ 371 Date: Dec. 8, 2023

(30) Foreign Application Priority Data
Jun. 11, 2021 (GB) 2108373.8

(51) Int. Cl. C22B 3/00; B01D 15/38; B01J 20/10; B01J 20/22; B01J 20/289; B01J 20/32; B01J 45/00; C02F 1/28; C02F 101/20; C22B 3/24; H01M 10/54

(52) U.S. Cl. CPC C22B 23/0484; B01D 15/3828; B01J 20/103; B01J 20/22; B01J 20/289; B01J 20/3204; B01J 20/321; B01J 20/3219; B01J 20/3255; B01J 45/00; C02F 1/288; C22B 3/24; H01M 10/54; C02F 1/281; C02F 1/285; C02F 2101/20

(57) ABSTRACT

Use of a separation material comprising picolinic acid ester or picolinic acid amide functional groups immobilised on a solid support to selectively remove Ni from an aqueous solution.

### FIELD OF THE INVENTION

The present invention relates to separation materials suitable for separating base metals, particularly those found in lithium ion batteries, methods of using the separation materials and methods for their manufacture.

### BACKGROUND OF THE INVENTION

As the use of lithium ion batteries increases, for example in consumer electronics and electric vehicle applications, resource demands for the metals employed in such batteries is increasing. Affected metals include Ni, Co, Mn and Li. Accordingly, there is an increased need for methods of recycling components including such metals, including lithium ion battery waste but also other metal containing materials such as base metal catalysts. Such recycling processes typically require effective separation of the metals concerned.

Accordingly, there remains a need for effective separation of metals such as Ni and/or Co, typically in the presence of other metals including Li and/or Mn.

### SUMMARY OF THE INVENTION

The present inventors have found that separation materials comprising picolinic acid amide or picolinic acid ester functional groups, e.g. picolinamide functional groups, immobilised on a solid support exhibit excellent Ni adsorption properties. Accordingly, they are useful for separating Ni from other metals in aqueous solutions. Due to their excellent affinity for Ni, such separation materials are useful for removing Ni from solutions with relatively high concentrations of Ni, and also for sequestering unwanted Ni impurities in low or trace levels in water and aqueous solutions.

Accordingly, in a first preferred aspect the present invention provides use of a separation material comprising picolinic acid amide or picolinic acid ester functional groups, e.g. picolinamide functional groups, immobilised on a solid support to selectively remove Ni from an aqueous solution. The present invention may provide use of a separation material comprising such functional groups immobilised on a solid support to selectively remove Ni from an aqueous solution in the presence of Co. The present invention may provide use of a separation material comprising such functional groups immobilised on a solid support to selectively remove Ni from an aqueous solution in the presence of Co and optionally Mn and/or Li.

In a second preferred aspect the present invention provides a method of selectively removing Ni from an aqueous solution, the method comprising contacting the aqueous solution with a separation material comprising picolinic acid amide or picolinic acid ester functional groups, e.g. picolinamide functional groups, immobilised on a solid support.

The present inventors have also found that the separation materials of the present invention are useful in the chromatographic interseparation of Ni from certain other metals. Accordingly, in a third preferred aspect the present invention provides use of a separation material comprising picolinic acid amide or picolinic acid ester functional groups, e.g. picolinamide functional groups, immobilised on a solid support to chromatographically separate Ni from one or more other metals in an aqueous solution. Typically, the one or more other metals includes Co, Mn and/or Li.

The present invention further provides a method of chromatographically separating Ni from one or more other metals in an aqueous solution, the method comprising flowing an inlet aqueous solution comprising Ni and one or more further metals through a stationary phase comprising a separation material comprising picolinic acid amide or picolinic acid ester functional groups, e.g. picolinamide functional groups, immobilised on a solid support, and sequentially eluting the Ni and one or more further metals to provide an elution fraction comprising Ni and one or more further elution fractions each comprising one or more of the further metals.

The present inventors have further found that the separation materials of the present invention are also suitable in the chromatographic separation of Co from Li and/or Mn. Accordingly, in a further preferred aspect the present invention provides use of a separation material comprising picolinic acid amide or picolinic acid ester functional groups, e.g. picolinamide functional groups, immobilised on a solid support to chromatographically separate Co from Li and/or Mn in an aqueous solution.

The present invention further provides a method of chromatographically separating Co from Li and/or Mn in an aqueous solution, the method comprising flowing an inlet aqueous solution comprising Co and Li and/or Mn through a stationary phase comprising a separation material comprising picolinic acid amide or picolinic acid ester functional groups immobilised on a solid support, and sequentially eluting the Co and Li and/or Mn to provide an elution fraction comprising Co and one or more further elution fractions each comprising Li and/or Mn.

The present invention further provides a separation material comprising picolinic acid amide or picolinic acid ester functional groups, e.g. picolinamide functional groups, immobilised on a solid support having a nickel loading capacity of at least 10 mg g⁻¹.

The present invention further provides a separation material comprising picolinic acid amide or picolinic acid ester functional groups, e.g. picolinamide functional groups, immobilised on a silica support.

The present invention further provides a separation material comprising picolinic acid amide or picolinic acid ester functional groups, e.g. picolinamide functional groups, immobilised on a solid support wherein the solid support is selected from a silica solid support, a silica-polymer composite solid support and/or an optionally cross-linked methacrylate solid support.

The present invention further provides a separation material comprising picolinic acid amide or picolinic acid ester functional groups, e.g. picolinamide functional groups, immobilised on a solid support wherein the solid support is not polystyrene.

The present invention further provides a method of preparing a separation material comprising picolinic acid amide or picolinic acid ester functional groups, e.g. picolinamide functional groups, immobilised on a solid support. For example, the method may comprise providing amine functional groups on the solid support (preferably primary amines) and reacting with picolinic acid.

### BRIEF DESCRIPTION OF THE DRAWINGS

FIGS. 1, 2 and 3 show breakthrough curves for Resins A, B and C at pH1 (Performance Example 1).

FIGS. 4, 5 and 6 show breakthrough curves for Resins A, B and C at pH2 (Performance Example 2).

FIG. 7 shows the results of a chromatographic separation using Resin A (Performance Example 4).

FIG. 8 shows that the performance of Resin A is retained following repeated Load/Elute cycles (Performance Example 5).

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

### Separation Material

The separation material of the present invention comprises picolinic acid amide or picolinic acid ester functional groups, e.g. picolinamide functional groups, immobilised on a solid support. The functional groups may by attached to the solid support via a covalent linker. For example, a picolinamide functional group and its attachment to the solid support may be illustrated by Formula 1:

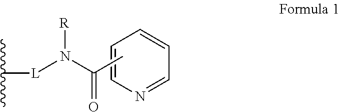

in which L is a covalent linker and R is H or optionally substituted, branched or straight chain C1-C6 alkyl.

The nature of the covalent linker (e.g. L) is not particularly limited in the present invention. It may be optionally substituted C1-C6 alkyl in which one or two of the C atoms have optionally been replaced with hetero atoms. The hetero atoms may be selected from O, N, S or Si, typically O or N, typically O. The covalent linker may be C1-C6 alkyl.

R is typically H or C1-C6 straight chain alkyl, e.g. H or C1-3 straight chain alkyl. R may preferably be H.

The picolinamide functional group may be a 2-picolinamide, 3-picolinamide or 4-picolinamide, preferably 2-picolinamide which chelates nickel at low pH.

The 2-picolinamide and its attachment to the solid support may be illustrated by Formula 2:

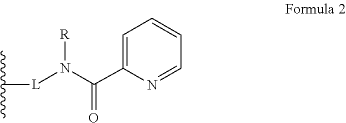

in which L is a covalent linker and R is H or optionally substituted, branched or straight chain C1-C6 alkyl as previously described.

The present invention provides a separation material comprising picolinic acid amide or picolinic acid ester functional groups, e.g. picolinamide functional groups, immobilised on a solid support having a nickel loading capacity of at least 10 mg g 1. The nickel loading capacity may be determined by contacting 20 mL of Ni sulphate solution having a Ni concentration of 200 ppm at pH 2.0 with 0.062 g of separation material and stirring at 25° C. for 18 hours. The concentration of Ni remaining in the solution is determined by ICP-OES and compared with a blank solution which has not been contacted with the separation material to determine the mass of Ni loaded on the separation material (the Ni loading capacity).

The solid support is typically a polymer or resin solid support. It may be in the form of beads. A particularly suitable solid support is silica. Without wishing to be bound by theory, the inventors believe that silica supports provide a high density of attachment points for the picolinamide functional group, providing a high density of binding sites for Ni, thereby providing a separation material with a high Ni capacity. Other suitable solid supports include optionally cross-linked methacrylate polymer solid supports and silica-polymer composite solid supports.

In some embodiments it may be preferred that the solid support is not polystyrene. The present inventors have found that the tendency of polystyrene to swell during loading and elution cycles mean that separation materials with a polystyrene solid support do not last as long.

### Selective Removal of Ni

The present invention provides use of a separation material comprising picolinic acid amide or picolinic acid ester functional groups, e.g. picolinamide functional groups, immobilised on a solid support to selectively remove Ni from an aqueous solution and a method of selectively removing Ni from an aqueous solution employing the separation material. The present invention further provides a method of chromatographically separating Ni from one or more other metals in an aqueous solution.

The aqueous solution may have a pH of less than 3, less than 2.5 or less than 2.1. It may have a pH of at least 0.5, 0.7, 0.8 or 0.9. For example, the pH may be in the range from 0.5 to 2.5. It may be particularly convenient that the pH is about 1, since this is the typical pH of base metal feeds from battery recycling processes. The separation material works particularly well at such pH, in contrast to other separation materials. For example, the pH may be less than 1.9, 1.7, 1.5, 1.3 or 1.1. Typically, it may be in the range from 0.5 to 1.5, e.g. 0.9 to 1.1.

The aqueous solution may be a recycling feed, for example it may be formed by acid leaching of nickel-containing solid material. The nickel-containing solid material may be battery waste. The battery waste may have been previously used within an electrical energy storage device, although this is not essential. The battery waste may be waste material generated during the production of batteries or materials, including for example waste intermediate materials or failed batches. In some embodiments, the battery waste is formed by mechanical and/or chemical processing of waste lithium ion batteries.

The aqueous solution includes Ni ions, typically Ni (II) ions. It typically also includes one or more further metal ions, for example one or more further metal ions selected from Co, Li, Mn, Fe, Al and Cu, for example one or more further metal ions selected from Co, Li, Mn and Fe, for example one or more further metal ions selected from Co, Li and Mn. The aqueous solution typically comprises Ni and Co, for example Ni, Co and Li, for example Ni, Co and Mn, for example Ni, Co, Li and Mn. In some embodiments, the aqueous solution comprises only trace amounts of additional metals beyond those recited. A trace amount of additional metal may be less than 10 mg/L, less than 5 mg/L, less than 1 mg/L or less than 0.1 mg/L.

As the skilled person will understand, the Ni is typically removed from the aqueous solution by sorption (e.g. adsorption) on the separation material. Without wishing to be bound by theory, the present inventors believe that the Ni become sorbed due to chemical interaction between the Ni ions and the picolinic acid amide or picolinic acid ester functional groups, e.g. picolinamide functional groups, present on the surface and optionally in the pores of the solid support.

In the present invention, Ni may be separated from other metals by loading the separation material with Ni ions (where the Ni ions become sorbed on the separation material) and subsequently contacting the separation material with an elution liquid to desorb the Ni ions. This cycle of loading and eluting may be repeated 2 or more, 3 or more, 4 or more, 5 or more, 8 or more, or 10 or more times. This is particularly advantageous as it permits recycling of the separation material and enables it to be used for a sustained period of time. Typically, the elution liquid is an aqueous solution having a pH less than 0.5, less than 0.3 or less than 0.1. It may have a pH of greater than −1. The elution liquid is typically an acid. A suitable elution liquid is 2M H₂SO₄. Other suitable elution liquids include HCl.

### Chromatographic Separation

The present inventors have found that the separation materials of the present invention are useful in the chromatographic interseparation of Ni from certain other metals in an aqueous solution. Typically, the aqueous solution is as defined above with respect to selective removal of Ni.

The method of chromatographically separating Ni from one or more other metals in an aqueous solution comprises flowing an inlet aqueous solution comprising Ni and one or more further metals through a stationary phase comprising the separation material of the present invention, and sequentially eluting the Ni and one or more further metals to provide and elution fraction comprising Ni and one or more further elution fractions each comprising one or more of the further metals.

Typically, Mn and/or Li may be selectively eluted using water or an aqueous solution with a pH greater than 3, 4, 5, 6 or 6.5. The pH may be less than 8 or less than 7.5.

Typically, Co may be selectively eluted using an aqueous solution with a pH greater than 0.5, 0.7, 0.8 or 0.9. It may have a pH less than 3, 2, or 1.5. The pH of the Co elution liquid may be sequentially decreased in this range to ensure substantially complete elution. For example, aqueous H₂SO₄ may be used.

Typically, Ni may be eluted using an aqueous solution having a pH less than 0.5, less than 0.3 or less than 0.1. It may have a pH of greater than −1. The elution liquid is typically an acid. A suitable elution liquid is 2M H₂SO₄. Other suitable elution liquids include HCl.

Typically, the metals are eluted in the sequence Mn and/or Li, then Co, then Ni. A water wash may be carried out following Ni elution.

The present inventors have further found that the separation materials of the present invention are also suitable in the chromatographic separation of Co from Li and/or Mn in aqueous solutions. The aqueous solution includes Co ions, typically Co (II) ions. It typically also includes one or more further metal ions, for example one or more further metal ions selected from Li, Mn, Fe, Al and Cu, for example one or more further metal ions selected from Li, Mn and Fe, for example one or more further metal ions selected from Li and Mn. The aqueous solution typically comprises Co and Li and/or Mn, typically Co, Li and Mn. In some embodiments, the aqueous solution comprises only trace amounts of additional metals beyond those recited. A trace amount of additional metal may be less than 10 mg/L, less than 5 mg/L, less than 1 mg/L or less than 0.1 mg/L.

The Co and Mn and/or Li may be selectively eluted as described above with reference to chromatographic methods where Ni is present.

### Method of Making Separation Material

The present invention further provides a method of preparing a separation material comprising picolinic acid amide or picolinic acid ester functional groups, e.g. picolinamide functional groups, immobilised on a solid support. For example, the method may comprise providing amine functional groups on the solid support (preferably primary amines) and reacting with picolinic acid. The solid support may be as defined above. The reaction with picolinic acid may be carried out in the presence of 1,1′-carbonyldiimidazole. The reaction with picolinic acid may be carried out for at least 5, 10 for 15 hours, e.g. under reflux conditions.

### EXAMPLES

### Preparation Example 1—Preparation of 3-Aminopropyl Functionalised Silica (“Silica-AP”)

Silica (20.0 g dry mass) was placed in a 250 mL three-neck round-bottom flask reactor. A mixture of (3-aminopropyl) trimethoxysilane (3.6 g, 3.6 mL) and toluene (60 mL) was prepared and added slowly to the reactor. Then the reactor was placed on a hotplate and fitted with a paddle stirrer powered by overhead motor with a gas tight stirrer gland. The mixture was stirred at 50 rpm and the reaction carried out overnight at an external temperature of 100° C. The reaction was allowed to cool down, filtered, washed with 3×20 mL of toluene and dried in a vacuum oven at 40° C.

### Preparation Example 2—Preparation of Picolinamide Functionalised Silica

Picolinic acid (0.75 g) was placed in a 250 mL three-neck round-bottom flask reactor. Then, 60 mL of dichloromethane (DCM) was added to the reactor and the reactor placed on a hotplate fitted with a paddle stirrer powered by overhead motor with a gas tight stirrer gland and a calcium chloride guard. The mixture was stirred until the picolinic acid was completely dissolved. Then, 1,1′-carbonyldiimidazole (CDI) (0.97 g) was slowly added to the reactor (bubbling, CO₂ by-product being released) and mixed for 30 minutes. Silica-AP (5.0 g dry mass, as prepared in Example 1) was added to the reactor. The mixture was stirred at 50 rpm and refluxed overnight (external temperature 50° C.). The reactor was allowed to cool down, the solid was filtered, washed with DCM, methanol and deionised water (3×20 mL each step) and dried in a vacuum oven at 40° C.

The reaction scheme for this reaction is below:

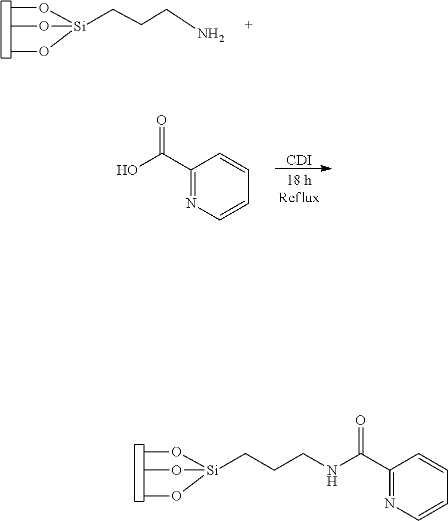

### Preparation Example 3—Preparation of Glycidoxypropyl Functionalised Silica

Silica (20.0 g dry mass) was placed in a 250 mL round bottom flask. In a separate conic flask, a mixture of (3-glycidoxypropyl) trimethoxysilane (4.1 g, 4.4 mL) and methanol (60 mL) was prepared and added slowly to the reactor. Then the reactor was placed in a rotatory evaporator and the reaction carried out for 5 hours, with a stirring speed of 50 rpm and an external temperature of 90° C. In the first 10-15 minutes all the methanol was evaporated from the reactor and collected in a separate vessel. The reaction was allowed to cool down, washed with 60 mL of methanol once and then washed with 60 mL of deionised water twice. The final product, silica-GOP, was filtered and dried in a vacuum oven at 40° C.

### Preparation Example 4—Preparation of Picolylamine Functionalised Silica

Silica-GOP prepared in Preparation Example 3 (10.0 g dry mass) was placed in a 250 mL three-neck round-bottom flask and placed on a hotplate with a paddle stirrer powered by overhead motor with a gas tight stirrer gland. Then, in a separate conic flask a mixture of 2-picolylamine (5.98 g, 5.7 mL) and methanol (30 mL) was prepared and added to the reactor. The mixture was stirred at 50 rpm and the reaction refluxed overnight (external temperature to 80° C.). The reactor was allowed to cool down, and the solid filtered and collected in a thimble and then washed with methanol with soxhlet extraction for 2 hours. Then, the final product, silica-GOP-PA, was filtered and dried in a vacuum oven at 40° C.

The reaction scheme for this reaction is below:

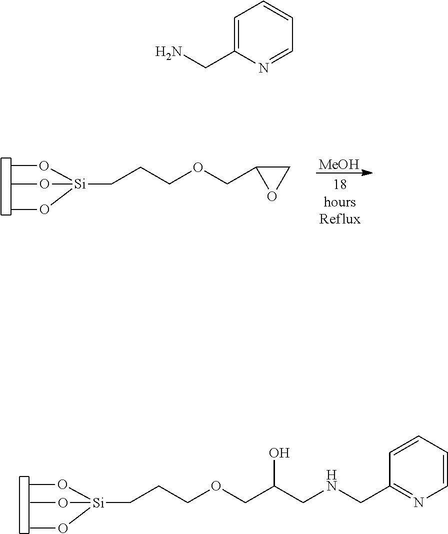 [SMILES: "MeOH" ; NCc1ccccn1 ; CO[Si](CCCOCC1CO1)(OC)OC ; CO[Si](CCCOCC(O)CNCc1ccccn1)(OC)OC]

### Preparation Example 5—Preparation of Picolinamide Functionalised Polystyrene

Picolinic acid (3.1 g) was dispersed in 30 mL of DCM in a 100-mL 3-neck round-bottom flask with continuous stirring by an over-head stirrer. Then, CDI (4.1 g) was added to the reactor with evolution of some effervescence due to the release of CO₂. Once the effervescence finished (approx. 30 min), an amine-functionalised poly(styrene-co-divinylbenzene), (Lewatit® VP OC 1065; 5.0 g), was added to the reactor and the reaction heated to reflux in anhydrous conditions (CaCl₂) guard) overnight. The final product was given as a dark-grey solid which was filtered off, washed with DCM by soxhlet extraction for 10 cycles, washed with water and dried under vacuum at 40° C. for 6 h.

The reaction scheme for this reaction is below:

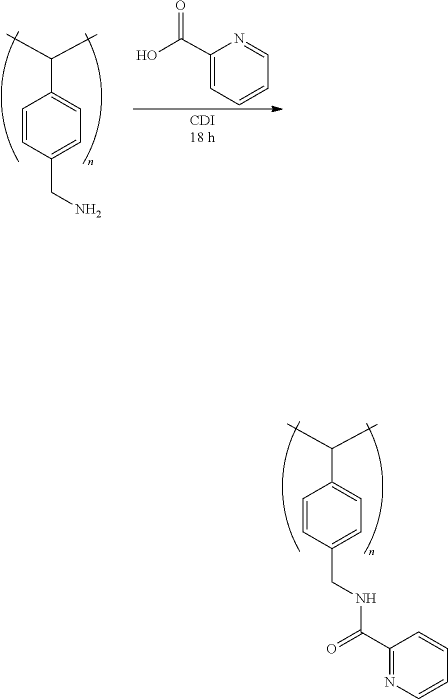

### Performance Example 1—Nickel Adsorption at pH 1

An aqueous feed solution containing Co(II), Fe(III), Li, Mn(II) and Ni each at a concentration of 500 mg L⁻¹ using the sulfate salts of each metal was prepared, the pH adjusted to pH 1.0 using sulfuric acid.

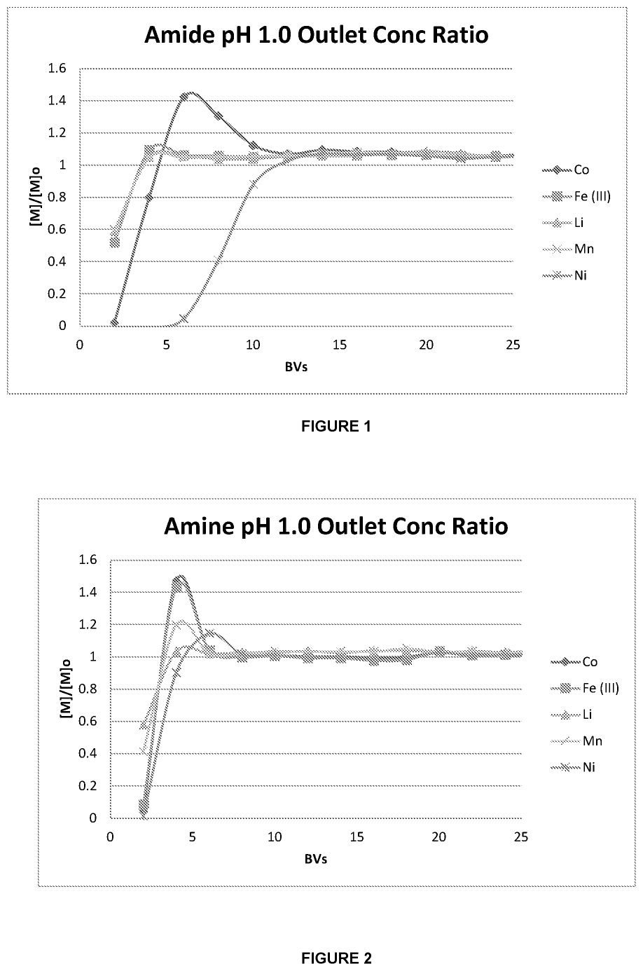

The feed solution was flowed through beds containing Resin A, Resin B and Resin C (resin details in Table 1 below). Resins were equilibrated using an acid rinse followed by flushing with water. FIGS. 1, 2 and 3 show the breakthrough curves for Resins A, B and C respectively.

TABLE 1

| | |
|---|---|
| Resin A | Silica-picolinamide as prepared in Preparation Example 2 |
| Resin B | Silica-picolylamine as prepared in Preparation Example 4 |
| Resin C | M4195 available from Dow Chemical (2-dipicolylamine |
| | functionalised polystyrene) |

The column used was 10 mm internal diameter with a packed length of 120 mm and total volume of 9.4 mL (deemed 1 bed volume, BV) operating at 6 BV/hr (0.94 mL/min, 56.4 mL/hr).

The results are shown in FIGS. 1, 2 and 3. FIG. 1 shows the results for Resin A, and illustrates that Ni was fully adsorbed for the first five bed volumes before it started breaking through. In contrast, the other metals in the feed began breaking through immediately. This demonstrates that Resin A selectively adsorbs Ni at pH 1 in the presence of Co, Fe, Li and Mn and is therefore suitable for separating Ni from these metals at pH 1. In contrast, FIG. 2 shows the results for Resin B, and demonstrates that Ni breakthrough is observed immediately. FIG. 3 shows the results for Resin C, and similarly Ni breakthrough is observed immediately. Accordingly, Resins B and C are not useful for selectively adsorbing Ni in the presence of Co, Fe, Li and Mn at pH 1.

This demonstrates that the picolinamide functional group is superior to both the picolylamine and 2-dipicolylamine functional groups for selectively adsorbing Ni.

The three resins tested where recycled using three bed volumes (28.2 mL) of the eluent chosen. Resin A and Resin B were both successfully stripped of 100% of the adsorbed nickel using 2M H₂SO₄. Removal of Ni from Resin C required eluting with ammonia. The MSDS indicated that swelling/degradation of the material occurs on contact with ammonia.

### Performance Example 2—Nickel Adsorption at pH 2

The protocol of Performance Example 1 was repeated, except that the feed solution was adjusted to pH 2.0 using sulfuric acid.

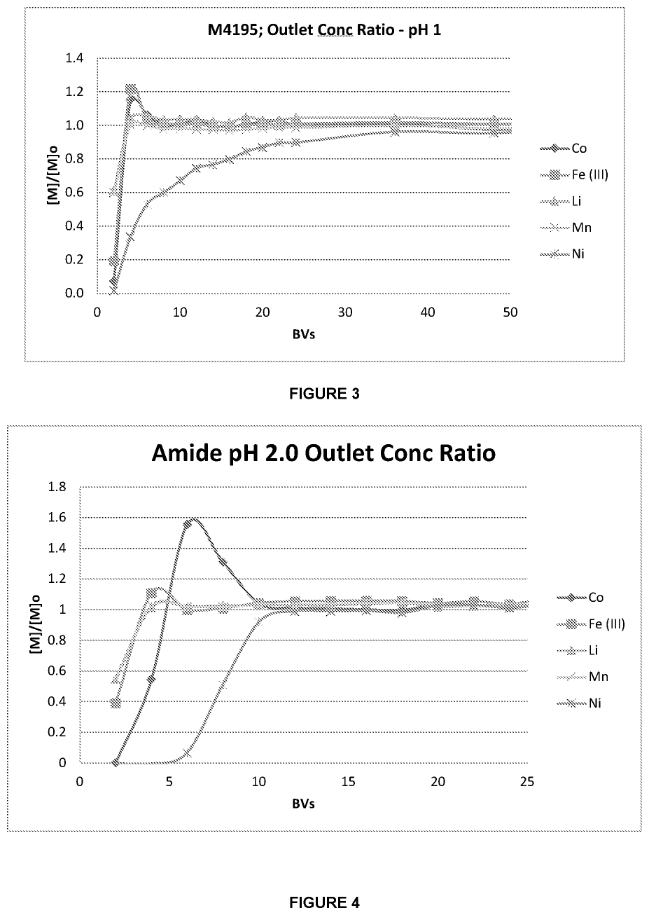

FIG. 4 shows the results for Resin A, again showing that Ni was fully adsorbed for the first five bed volumes. FIG. 5 shows the results for Resin B. There is greater Ni adsorption compared with this Resin B performance at pH 1.0, but Ni breakthrough is still seen immediately. FIG. 6 shows the results for Resin C. A greater Ni adsorption is observed compared with Resin C performance at pH 1.0.

### Performance Example 3—Nickel Loading

The nickel loading capacity of Resin A and Resin D (picolinamide functionalised polystyrene as prepared in Preparation Example 5) was tested using a single point capacity test according to the following protocol.

Determination of metal adsorption capacity of the resins was carried out using 20 mL of nickel sulphate solution with a nickel concentration of 200 ppm at pH 2.0. The metal solution was made by dissolving the appropriate mass of the sulfate salt in deionised water and the pH adjusted with sulfuric acid. The different materials are weighed out in multiple parallel tubes with a set mass of 0.062 g. The resin and the solution were contacted and stirred for 18 hours. All samples, including an un-treated blank were analysed by ICP-OES. The metal concentration of the blank (un-treated) sample is compared against the concentration of the treated sample and the metal capacity is described as mass of metal adsorbed by mass of resin (mg g⁻¹).

The results are shown in Table 2 below:

TABLE 2

| Resin | Nickel Capacity | |
|---|---|---|
| Resin A | 15 | mg g⁻¹ |
| Resin D | 3 | mg g⁻¹ |

These results demonstrate that picolinamide-functionalised silica has a higher capacity for nickel than picolinamide-functionalised polystyrene, though both demonstrate significant nickel uptake. It is believed that a polystyrene-based resin is not suitable for repeated load/elute cycles due to susceptibility to swelling.

### Performance Example 4—Chromatography Separations

A solution containing Co(II), Li, Mn(II) and Ni at pH 2 (each metal at a concentration of 500 mg L⁻¹ as its sulfate salt) was subjected to chromatographic separation. The solution was the mobile phase, and Resin A the stationary phase. The bed volume (BV) was 9.4 mL.

An initial injection of 1 BV was pumped through the stationary phase. It was observed that Li and Mn were not adsorbed by the resin and the Ni and Co were loaded onto the resin. A gradient elution was then run with H₂O to wash off remaining Li and Mn which were not adsorbed. This was followed by 3 BV each of solutions of H₂SO₄ of varying pH, followed by a final water wash. The full elution phase was as set out in Table 3 below.

TABLE 3

| | |
|---|---|
| H₂O | 3 BV |
| H₂SO₄ solution pH 1.3 | 3 BV |
| H₂SO₄ solution pH 1.0 | 3 BV |
| 2M H₂SO₄ | 3 BV |
| H₂O | 3 BV |

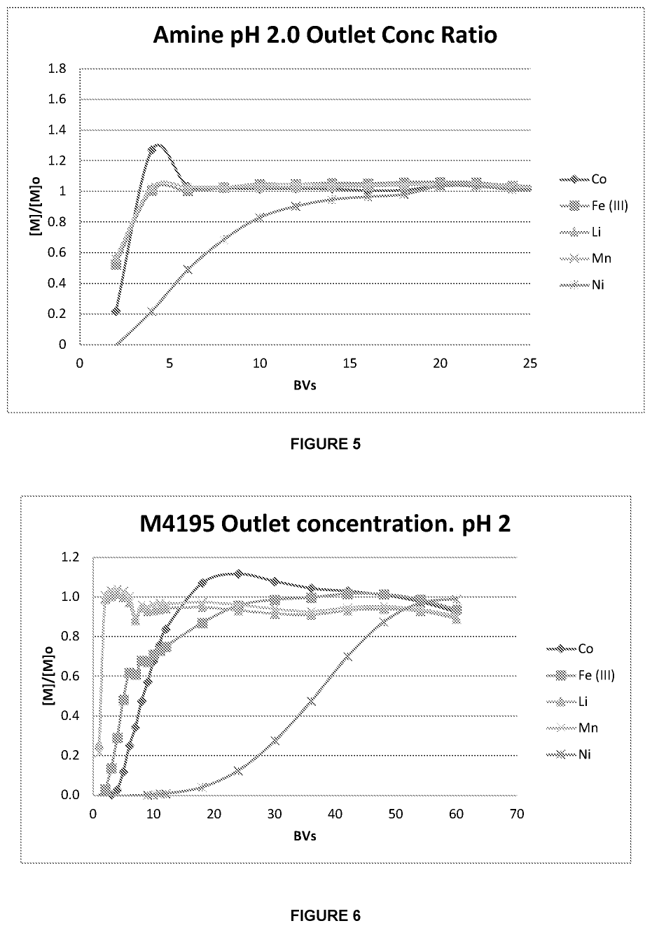

The results are shown in FIG. 7. This shows that Ni and Co can be successfully separated from each other (and from Li and Mn) using chromatography separation with a picolinamide-functionalised resin. Most of the Co can be eluted with pH 1.3 H₂SO₄ but requires a low pH (1.0) to be completely eluted. Ni remains on the media in these conditions and is eluted using 2M H₂SO₄. Thus, complete Ni and Co separation is achieved.

### Performance Example 5—Stability of Resin A

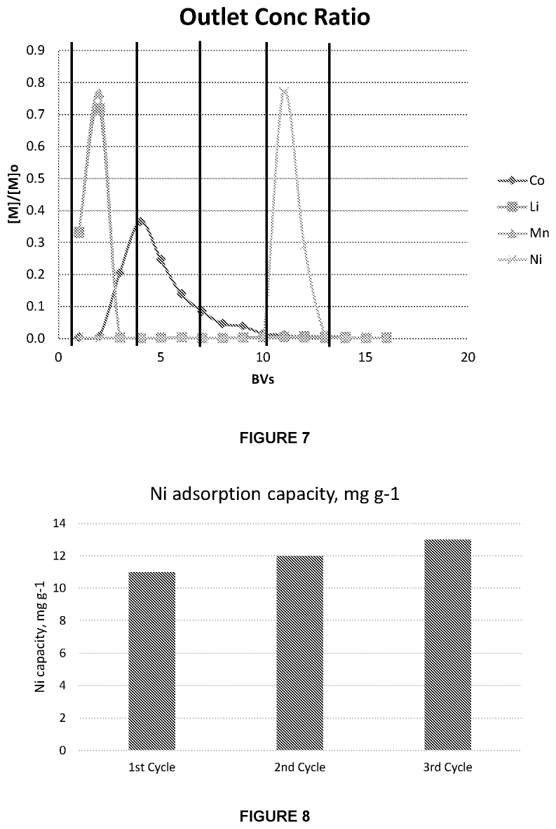

The protocol of Performance Example 1 was repeated for Resin A, except that the feed solution was adjusted to pH 2.0 using sulfuric acid and the loading cycle was repeated two further times after the elution of nickel with 2 M sulfuric acid. The results shown in FIG. 8 illustrate that the Ni capacity was retained following repeated load/elute cycles illustrating the stability of Resin A.

### Picolinic Acid Ester Example

The previous examples utilized picolinic acid amide (picolinamide) functional groups. However, it is also possible to utilize corresponding picolinic acid ester groups in accordance with other examples of the present invention. In this regard, it has been found that picolinic acid esters can also chelate nickel. For example, an acidic solution of ethyl 2-picolinate (0.04 M) and nickel (0.01 M) was prepared and chelation was confirmed by a colour change of the solution from green to blue colour, which is the same colour as the nickel-picolinamide complex.

While this invention has been particularly shown and described with reference to certain examples, it will be understood to those skilled in the art that various changes in form and detail may be made without departing from the scope of the invention as defined by the appended claims.

1. Use of a separation material comprising picolinic acid ester or picolinic acid amide functional groups immobilised on a solid support to selectively remove Ni from an aqueous solution.

2. Use according to claim 1 wherein the use comprises selectively removing Ni from an aqueous solution in the presence of Co and optionally Mn and/or Li.

3. Use according to claim 1 or claim 2 wherein the functional groups comprise a picolinamide functional group.

4. Use according to claim 3 wherein the picolinamide functional group and its attachment to the solid support is illustrated by Formula 1: 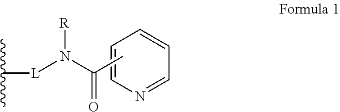
in which L is a covalent linker and R is H or optionally substituted, branched or straight chain C1-C6 alkyl.

5. Use according to any one of claim 3 or 4, wherein the picolinamide functional group is a 2-picolinamide.

6. Use according to any one of the preceding claims wherein the solid support is selected from a silica solid support, a silica-polymer composite solid support and/or an optionally cross-linked methacrylate solid support.

7. Use according to claim 6 wherein the solid support is a silica solid support.

8. Use according to any one of the preceding claims wherein the aqueous solution has a pH in the range from 0.5 to 2.5.

9. Use according to claim 8 wherein the aqueous solution has a pH in the range from 0.5 to 1.5.

10. Use according to any one of the preceding claims wherein the aqueous solution is a recycling feed, optionally derived from battery waste.

11. A method of selectively removing Ni from an aqueous solution, the method comprising contacting the aqueous solution with a separation material comprising picolinic acid ester or picolinic acid amide functional groups immobilised on a solid support.

12. A method of chromatographically separating Ni from one or more other metals in an aqueous solution, the method comprising flowing an inlet aqueous solution comprising Ni and one or more further metals through a stationary phase comprising a separation material comprising picolinic acid ester or picolinic acid amide functional groups immobilised on a solid support, and sequentially eluting the Ni and one or more further metals to provide an elution fraction comprising Ni and one or more further elution fractions each comprising one or more of the further metals.

13. A method of chromatographically separating Co from Li and/or Mn in an aqueous solution, the method comprising flowing an inlet aqueous solution comprising Co and Li and/or Mn through a stationary phase comprising a separation material comprising picolinic acid ester or picolinic acid amide functional groups immobilised on a solid support, and sequentially eluting the Co and Li and/or Mn to provide an elution fraction comprising Co and one or more further elution fractions each comprising Li and/or Mn.

14. A separation material comprising picolinic acid ester or picolinic acid amide functional groups immobilised on a solid support having a nickel loading capacity of at least 10 mg g⁻¹.

15. A separation material comprising picolinic acid ester or picolinic acid amide functional groups immobilised on a solid support wherein the solid support is selected from a silica solid support, a silica-polymer composite solid support and/or an optionally cross-linked methacrylate solid support.
